(19) United States
(12) Patent Application Publication
(10) Pub. No.: US 2014/0218638 A1
(43) Pub. Date: Aug. 7, 2014

(54) TOUCH SCREEN PANEL AND METHOD OF MANUFACTURING THE SAME

(71) Applicant: Samsung Display Co., Ltd., Yongin-City (KR)

(72) Inventors: Sung-Ku KANG, Yongin-City (KR); Byeong-Kyu JEON, Yongin-City (KR); Hee-Woong PARK, Yongin-City (KR)

(21) Appl. No.: 14/034,075

(22) Filed: Sep. 23, 2013

(30) Foreign Application Priority Data
Feb. 5, 2013 (KR) 10-2013-0012891

(51) Int. Cl. G02F 1/1333

(52) U.S. Cl. CPC G02F 1/13338
USPC 349/12; 29/622

(57) ABSTRACT

A method of manufacturing a touch screen panel includes patterning a first conductive layer formed on a substrate to form first sensing electrodes connected in a first direction, sequentially forming an insulating layer and a second conductive layer on the substrate where the first sensing electrode are formed, and patterning the insulating layer and the second conductive layer together to overlap each other so that second electrodes connected in a second direction that intersects the first direction are formed. A touch screen panel comprises a substrate, first sensing electrodes formed on the substrate and connected to each other in a first direction, second sensing electrodes connected to each other in a second direction intersecting the first direction, and an insulating layer formed between the first sensing electrodes and the second sensing electrodes and overlapping the second sensing electrodes.

### CLAIM OF PRIORITY

This application makes reference to, incorporates into this specification the entire contents of, and claims all benefits accruing under 35 U.S.C. §119 from an application earlier filed in the Korean Intellectual Property Office on Feb. 5, 2013 and there duly assigned Serial No. 10-2013-0012891.

### BACKGROUND OF THE INVENTION

1. Field of the Invention

The present invention relates to a touch screen panel and a method of manufacturing the same, and more particularly, to a touch screen panel capable of reducing manufacturing processes and a method of manufacturing the same.

2. Description of the Related Art

A touch screen panel is an input device capable of selecting the indication content displayed on the screen of an image display device by a human hand or an object to input the command of a user.

Therefore, the touch screen panel is provided on the front face of the image display device to convert a contact position of the human hand or the object into an electrical signal. Therefore, the indication content selected in the contact position is received as an input signal.

Since the touch screen panel may replace an additional input device coupled to the image display device to operate such as a keyboard and a mouse, the range of use is gradually increasing.

Methods of realizing a touch screen panel include a resistance layer method, a photo-sensing method, and an electro-capacitive method.

Among the above methods, the widely used electro-capacitive touch screen panel senses a change in capacitance formed by a conductive sensing electrode with another peripheral sensing electrode or a ground electrode when the human hand or the object contacts the touch screen panel to convert the contact position into the electrical signal.

For this purpose, the electro-capacitive touch screen panel includes a plurality of first sensing electrodes formed to be connected in a first direction, a plurality of second sensing electrodes formed to be connected in a second direction, and an insulating layer interposed between the first sensing electrodes and the second sensing electrode to grasp coordinates of the contact position.

The first and second sensing electrodes and the insulating layer are formed in different processes.

For example, processes of patterning a first conductive layer to form the first sensing electrodes, and patterning an insulating layer on the first sensing electrodes and patterning a second conductive layer or a bridge pattern on the insulating layer to form the second sensing electrodes must be performed.

For this purpose, since exposure and development processes must be performed in the respective patterning processes, processes are complicated and manufacturing efficiency is deteriorated.

### SUMMARY OF THE INVENTION

Accordingly, the present invention has been developed to provide a touch screen panel capable of reducing manufacturing processes and a method of manufacturing the same.

In order to achieve the foregoing and/or other aspects of the present invention, there is provided method of manufacturing a touch screen panel, including patterning a first conductive layer formed on a substrate to form first sensing electrodes connected in a first direction, sequentially forming an insulating layer and a second conductive layer on the substrate where the first sensing electrode are formed, and patterning the insulating layer and the second conductive layer together to overlap each other so that second electrodes connected in a second direction that intersects the first direction are formed.

The insulating layer may be a photosensitive layer.

In forming the second sensing electrodes, the photosensitive layer may be exposed and developed by a photolithography method so that the photosensitive layer and the second conductive layer may be patterned together.

In forming the second sensing electrodes, as the photosensitive layer is removed, the second conductive layer and the photosensitive layer may be removed together.

The first and second conductive layers may be formed of a transparent electrode material.

The second conductive layer may be formed of metal nanowires.

The method may further include forming outside wiring lines for connecting the first sensing electrodes and the second sensing electrodes to an external driving circuit in units of lines in the first direction and the second direction.

The substrate may be divided into a touch active area and a touch non-active area outside the touch active area. The first and second sensing electrodes may be formed in the touch active area and the outside wiring lines may be formed in the touch non-active area.

The substrate may be a thin film substrate formed of at least one selected from a group consisting of polyethylene terephthalate (PET), polycarbonate (PC), acryl, polymethylmethacrylate (PMMA), triacetyl cellulose (TAC), polyethersulfone (PES), and polyimide (PI).

There is provided a touch screen panel, including a substrate, first sensing electrodes formed on the substrate and connected to each other in a first direction, second sensing electrodes connected to each other in a second direction that intersects the first direction, and an insulating layer formed between the first sensing electrodes and the second sensing electrodes so as to overlap the second sensing electrodes.

The insulating layer may be a photosensitive layer.

The photosensitive layer may have the same shape as that of the second sensing electrodes.

As described above, according to the present invention, it is possible to provide the touch screen panel capable of reducing the patterning process by patterning the insulating layer and the conductive layer on the insulating layer together to overlap each other and the method of manufacturing the same.

In particular, since a common organic insulating layer is replaced by the photosensitive layer, and the conductive layer is removed when the photosensitive layer is removed, the exposure, development and etching processes in the patterning process may be remarkably reduced.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view schematically illustrating an example of a touch screen panel according to an embodiment of the present invention;

FIGS. 2A to 2D are perspective views illustrating a method of manufacturing the touch screen panel of FIG. 1; and

FIG. 3 is a perspective view of a touch screen panel according to another embodiment of the present invention.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

Hereinafter, the embodiments of the present invention will be described in detail with reference to the accompanying drawings.

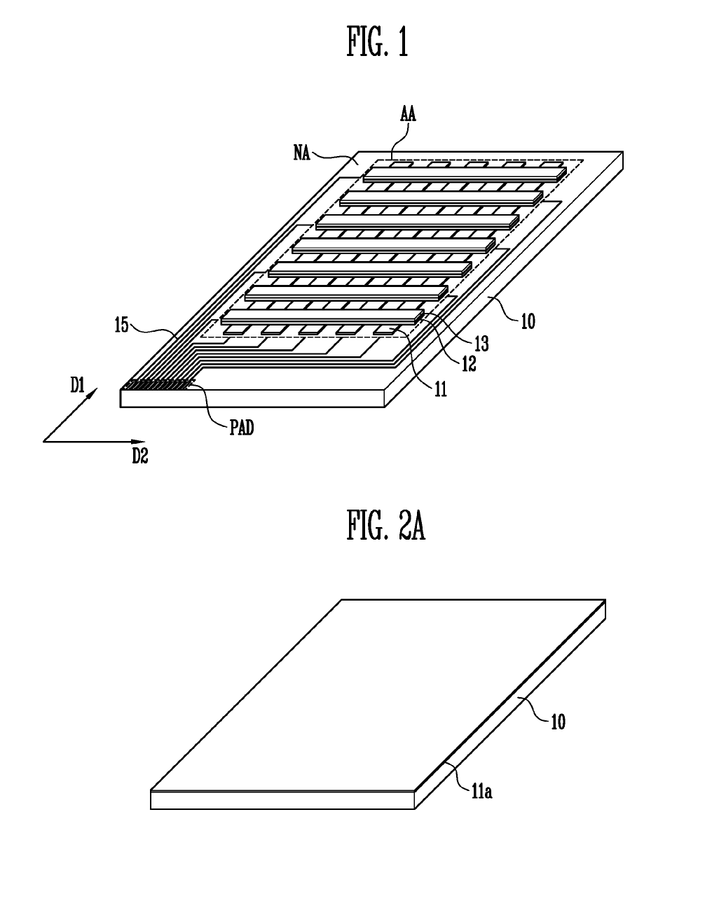

FIG. 1 is a perspective view schematically illustrating an example of a touch screen panel according to an embodiment of the present invention.

Referring to FIG. 1, a touch screen panel according to an embodiment of the present invention includes a substrate 10, first sensing electrodes 11, an insulating layer 12, second sensing electrodes 13, and outside wiring lines 15.

The substrate 10 may be divided into a touch active area AA that overlaps an image display area and in which the sensing electrodes 11 and 13 are formed so that a touch input may be performed, and a touch non-active area NA that is positioned on the outside of the touch active area AA and in which the outside wiring lines 15 are formed.

The touch non-active area NA, as a light shielding area that overlaps an image non-display area, surrounds the touch active area AA.

The substrate 10 is formed of a transparent material having a flexible characteristic and high thermal and chemical resistance, and may be a thin film substrate formed of at least one selected from the group consisting of, for example, polyethylene terephthalate (PET), polycarbonate (PC), acryl, polymethylmethacrylate (PMMA), triacetyl cellulose (TAC), polyethersulfone (PES), and polyimide (PI).

The first sensing electrodes 11 are arranged in the active area AA at uniform intervals and are electrically connected to each other in a first direction D1.

The insulating layer 12 is formed between the first sensing electrodes 11 and the second sensing electrodes 13 to electrically insulate the first sensing electrodes 11 and the second sensing electrodes 13 from each other.

The second sensing electrodes 13 are arranged in a different layer from that of the first sensing electrodes 11 at uniform intervals and are electrically connected to each other in a second direction D2 that intersects the first direction D1.

According to the present embodiment, the sensing electrodes 11 and 13 are linear stripe patterns. However, the shape of the sensing electrodes 11 and 13 may have various modifications and the present invention is not limited to the above.

The sensing electrodes 11 and 13 may be formed of a transparent electrode material such as indium tin oxide (ITO) to transmit light and may be formed by depositing conductive material on the substrate 10 and patterning the deposited conductive material by a photoresist method.

Since the first and second sensing electrodes 11 and 13, respectively, are formed in a different process from that of the insulating layer 12 and exposure and development processes must be performed in the respective patterning processes, processes are complicated and manufacturing efficiency is deteriorated.

Therefore, according to the present invention, the insulating layer 12 and a second conductive layer in which the second sensing electrodes 13 are formed are patterned together to overlap each other.

Therefore, it is possible to provide a touch screen panel capable of reducing patterning processes of the insulating layer 12 and the sensing electrodes 11 and 13, and a method of manufacturing the same.

Concretely, the insulating layer 12 has the same shape as that of the second sensing electrodes 13 formed thereon.

Here, the insulating layer 12 may be formed of a photosensitive layer such as dry film resist (DFR), and the second sensing electrodes 13 may be formed of the transparent electrode material such as ITO or metal nanowires such as AgNW.

Since ITO or metal nanowires of which the second sensing electrodes 13 are formed transmit light, a photolithography process may be performed on a photosensitive layer of which the insulating layer 12 is formed.

That is, in a process of exposing and developing the photosensitive layer in the photolithography method to pattern the photosensitive layer, the metal nanowires conductive layer on the photosensitive layer is patterned together.

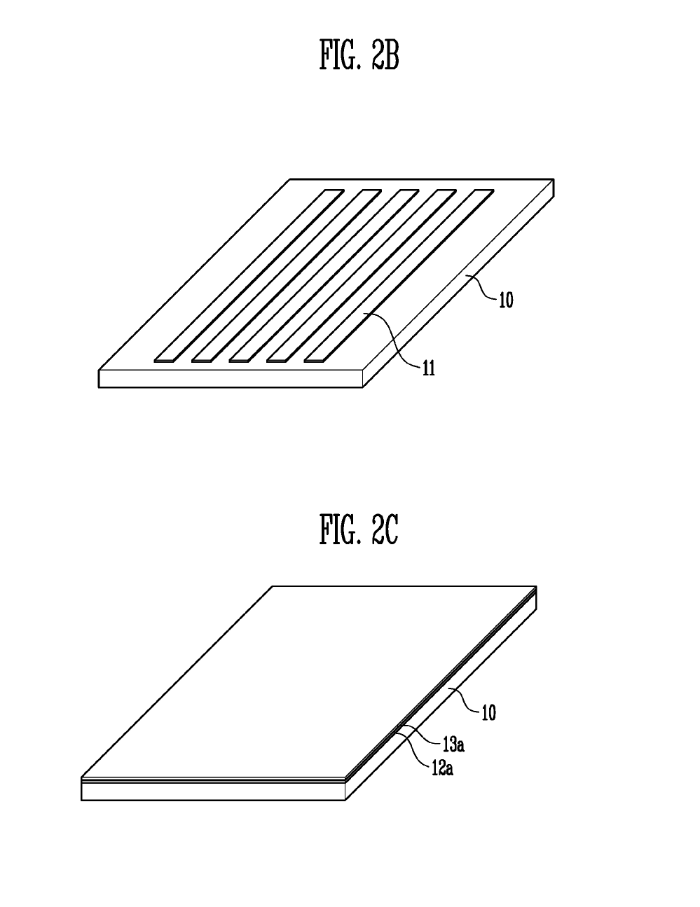

The method of manufacturing the touch screen panel will be described with reference to FIGS. 2A to 2D.

On the other hand, the outside wiring lines 15 for connecting the first sensing electrodes 11 and the second sensing electrodes 13 to an external driving circuit (not shown) in units of lines in the first direction D1 and the second direction D2 are electrically connected to the first and second sensing electrodes 11 and 13 in units of row lines and column lines so as to connect the first and second sensing electrodes 11 and 13, respectively, to an external driving circuit such as a position detecting circuit through a pad unit PAD.

The outline wiring lines 15, arranged in the touch non-active area NA outside the touch screen panel to avoid the touch active area AA in which an image is displayed, may be formed of a low resistance metal material such as Mo, Ag, Ti, Cu, Al, and Mo/Al/Mo other than the transparent electrode material used for forming the sensing electrodes.

When an object, such as a human hand or a stylus pen, contacts the above-described electro-capacitive touch screen panel, a change in capacitance in accordance with a contact position is transmitted from the sensing electrodes 11 and 13 to the driving circuit via the outside wiring lines 15 and the pad unit PAD. Next, the change in capacitance is converted into an electrical signal by an X and Y input processing circuit (not shown) so that a contact position is grasped.

FIGS. 2A to 2D are perspective views illustrating a method of manufacturing the touch screen panel of FIG. 1.

First, referring to FIG. 2A, a first conductive layer 11a is formed on the substrate 10.

Here, the substrate 10 may be a top substrate of a display panel, an additional touch panel substrate, or a window substrate.

The first conductive layer 11a for forming the first sensing electrodes 11 may be formed by depositing a transparent electrode material, such as ITO, on an entire surface of the substrate 10.

Next, referring to FIG. 2B, the first conductive layer 11a is patterned so that the first sensing electrodes 11 connected in the first direction are formed.

For example, a photolithography process and an etching process, using a mask (not shown) in which a pattern corresponding to the first sensing electrodes 11 is formed, may be performed on the first conductive layer 11a.

Next, referring to FIG. 2C, the insulating layer 12 and the second conductive layer 13 are sequentially formed on the substrate 10 where the first sensing electrodes 11 are formed.

The insulating layer 12 may be formed by coating liquid photoresist or laminating a photosensitive film such as DFR. A positive type in which an exposed part may be removed by development may be used.

Additionally, a baking process for enhancing a combination force between the photosensitive layer and top and bottom conductive layers may be further performed.

A second conductive layer 13a for forming the second sensing electrodes 13 may be formed by depositing the transparent electrode material such as ITO on the entire surface of the insulating layer 12, or may be formed of the metal nanowires such as AgNW.

Next, referring to FIG. 2D, the insulting layer 12 and the second conductive layer 13a are patterned together to overlap each other so that the second sensing electrodes 13 connected in the second direction are formed.

Concretely, when a mask (not shown), in which a pattern corresponding to the second sensing electrodes 13 is formed, is arranged on the second conductive layer 13a and is exposed to a light source such as ultraviolet (UV) rays, a process of exposing the photosensitive layer is performed by light that passes through the second conductive layer 13a.

Then, the photosensitive layer is developed so that the exposed region is removed. Therefore, the insulating layer 12 and the second conductive layer 13a are patterned together.

As the photosensitive layer of an area exposed by a developing solution is removed, the second conductive layer 13a on the photosensitive layer is removed together.

In particular, when the second conductive layer 13a is formed of the metal nanowires, since the second conductive layer 13a has an extremely small thickness, the second conductive layer 13a may be easily removed.

As described above, as an organic insulating layer is replaced by the photosensitive layer and the photosensitive layer is removed, the conductive layer is removed together so that exposure, development, and etching processes in the patterning process may be remarkably reduced.

Additionally, a baking process for enhancing a combination force between the insulating layer 12 and the second sensing electrodes 13 may be further performed.

On the other hand, after forming the second sensing electrodes 13, the outside wiring lines 15 illustrated in FIG. 1 may be further formed of a low resistance material having lower surface resistance than that of the transparent electrode material, such as a triple layer of Mo/Al/Mo or a chrome layer.

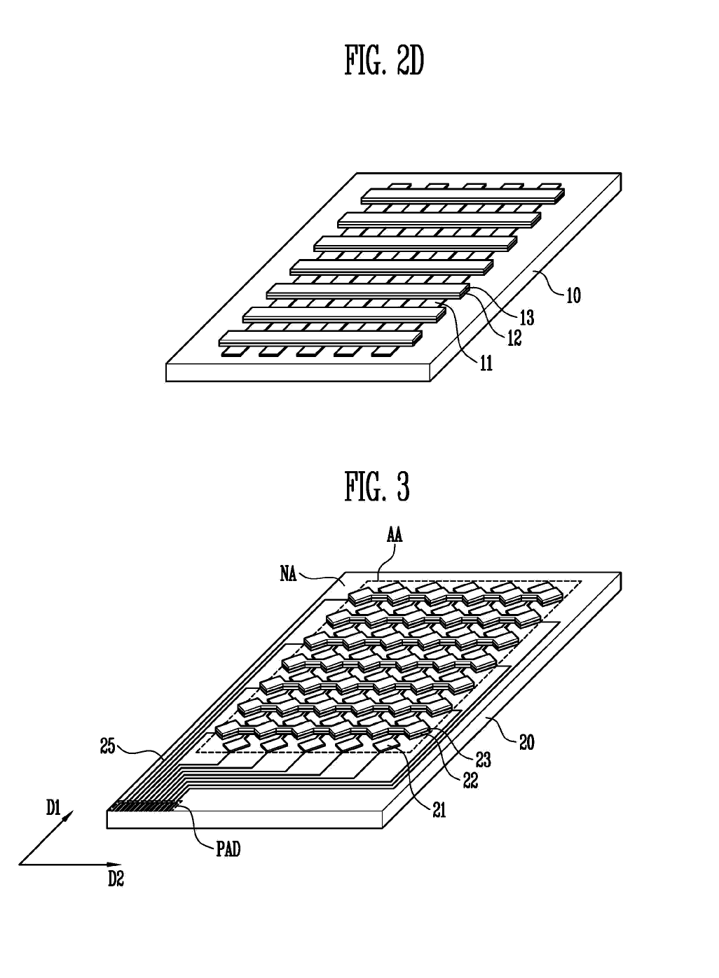

FIG. 3 is a perspective view of a touch screen panel according to another embodiment of the present invention.

The above-described disclosure may be referred to with respect to the elements denoted by the same reference numerals as those of the above-described elements and redundant description of the elements will be omitted.

Referring to FIG. 3, sensing electrodes 21 and 23 according to the present embodiment may be formed in the form of diamonds so as not to overlap each other.

Concretely, the first sensing electrodes 21 are arranged in the touch active area AA and are electrically connected to each other in the first direction D1 and the second sensing electrodes 23 are arranged between the first sensing electrodes 21 not to overlap the first sensing electrodes 21 and are electrically connected to each other in the second direction D2.

That is, the first sensing electrodes 21 and the second sensing electrodes 23 are alternately arranged so as to be connected in different directions.

The first sensing electrodes 21 and the second sensing electrodes 23 are formed in different layers with an insulating layer 22 interposed therebetween. Although not shown, connecting patterns for connecting the sensing electrodes 21 and 23 may overlap each other.

As in the first embodiment described above, the second sensing electrodes 23 and the insulating layer 22 are patterned together to overlap each other.

In another embodiment, the sensing electrodes may be in the form of metal meshes realized not by the transparent electrode material but by minute metal lines.

The shape and material of the sensing electrodes and the outside wiring lines formed on the substrate may have various modifications, and the present invention is not limited to the above.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of manufacturing a touch screen panel, comprising the steps of:
patterning a first conductive layer formed on a substrate to form first sensing electrodes connected in a first direction;
sequentially forming an insulating layer and a second conductive layer on the substrate where the first sensing electrodes are formed; and
patterning the insulating layer and the second conductive layer together to overlap each other so that second electrodes, connected in a second direction intersecting the first direction, are formed.

2. The method as claimed in claim 1, wherein the insulating layer is a photosensitive layer.

3. The method as claimed in claim 2, wherein, in forming the second sensing electrodes, the photosensitive layer is exposed and developed by a photolithography method so that the photosensitive layer and the second conductive layer are patterned together.

4. The method as claimed in claim 3, wherein, in forming the second sensing electrodes, as the photosensitive layer is removed, the second conductive layer and the photosensitive layer are removed together.

5. The method as claimed in claim 1, wherein the first and second conductive layers are formed of a transparent electrode material.

6. The method as claimed in claim 1, wherein the second conductive layer is formed of metal nanowires.

7. The method as claimed in claim 1, further comprising the step of forming outside wiring lines for connecting the first sensing electrodes and the second sensing electrodes to an external driving circuit in units of lines in the first direction and the second direction.

8. The method as claimed in claim 7, wherein the substrate is divided into a touch active area and a touch non-active area outside the touch active area; and
wherein the first and second sensing electrodes are formed in the touch active area and the outside wiring lines are formed in the touch non-active area.

9. The method as claimed in claim 1, wherein the substrate is a thin film substrate formed of at least one selected from a group consisting of polyethylene terephthalate (PET), polycarbonate (PC), acryl, polymethylmethacrylate (PMMA), triacetyl cellulose (TAC), polyethersulfone (PES), and polyimide (PI).

10. A touch screen panel, comprising:
a substrate;
first sensing electrodes formed on the substrate and connected to each other in a first direction;
second sensing electrodes connected to each other in a second direction intersecting the first direction; and
an insulating layer formed between the first sensing electrodes and the second sensing electrodes and overlapping the second sensing electrodes.

11. The touch screen panel as claimed in claim 10, wherein the insulating layer is a photosensitive layer.

12. The touch screen panel as claimed in claim 11, wherein he photosensitive layer has a same shape as a shape of the second sensing electrodes.

13. The touch screen panel as claimed in claim 10, further comprising outside wiring lines connecting the first sensing electrodes and the second sensing electrodes to an external driving circuit in units of lines in the first direction and the second direction.

14. The touch screen panel as claimed in claim 10, wherein the substrate is a thin film substrate formed of at least one selected from a group consisting of polyethylene terephthalate (PET), polycarbonate (PC), acryl, polymethylmethacrylate (PMMA), triacetyl cellulose (TAC), polyethersulfone (PES), and polyimide (PI).
